(19) United States
(12) Patent Application Publication
(10) Pub. No.: US 2022/0292593 A1
(43) Pub. Date: Sep. 15, 2022

(54) SYSTEM AND METHOD FOR SYNCHRONOUS OR ASYNCHRONOUS PROVISION OF ON-DEMAND ONLINE SERVICES, SKILLS, OR KNOWLEDGE

(71) Applicant: Mohamed Khalil Watfa, Dubai (AE)

(72) Inventor: Mohamed Khalil Watfa, Dubai (AE)

(21) Appl. No.: 17/198,512

(22) Filed: Mar. 11, 2021

(51) Int. Cl. G06Q 30/08; G06Q 30/06; G06F 16/9535

(52) U.S. Cl. CPC G06Q 30/08; G06Q 30/0631; G06F 16/9535; G06Q 50/20

(57) ABSTRACT

Systems, methods and computer program to automatically match and facilitate an online service, skill, talent or knowledge providers (referred to as tutors) with corresponding consumers (referred to as tutees) for online tutoring session deliveries in either a synchronous (real-time) or asynchronous (pre-recorded material) manners. Automatic promotional videos are created for each tutor based on their previously recorded tutoring sessions and automatic ordering and swapping of the tutoring sessions search categories are done based on the calculated interest scores of those categories. A reverse bidding tutoring session request with a maximum tutee budget is initiated to identify interested tutors. Positive post-session reviews result in automatic endorsements of talents for both the tutors and the tutees. New tutorial topics with specific budget goals are delivered if enough tutees contribute. The matching system provides reward points to tutors and tutees based on their positive interactions using the system.

### FIELD OF THE INVENTION

The present invention relates to the field of on-line scheduling and matching and more particularly to the coordination and management of an on-demand service request system linking individuals who have skills, talents, or knowledge or provide unique services to those who are searching for those skills, talents, services or knowledge in a synchronous or an asynchronous online session.

### BACKGROUND

For several decades now, the employment rate among around the world is falling. Although employment rate has increased in some parts of the world, there are many talented and skilled individuals who do not have full time jobs. Over the period from 1999 to 2018, the overall annual employment-to-population ratio fell from 64.3 percent to 60.4 percent, a decline of 3.8 percentage points. In addition to that, given the recent pandemic, the salaries people are earning are sometimes not enough for family and personal expenses. With people working fewer hours and with a resulting earnings gap to close, there's arguably never been a better time to provide opportunities for people to work during their spare time from home. Whether it's to help make ends meet, or to follow their passion, or maybe even both, technology can make that happen. With technological advancements including the fast internet speeds, and the excessive usage lately of video conferencing tools such as ZOOM, WebEx and Microsoft teams among others, it is now possible to virtually connect people from all parts of the world. People can work around their existing commitments to earn extra money.

Whether it's to help make ends meet, or to follow their passion, or maybe even both, technology can make that happen. With technological advancements including the fast internet speeds, and the excessive usage lately of video conferencing tools such as ZOOM, WebEx and Microsoft teams among others, it is now possible to virtually connect people from all parts of the world. People can work around their existing commitments to earn extra money. At the same time, the recent pandemic forced many people to stay home in lockdowns and be familiarized with technology adoption systems. Online teaching and learning also became a norm for the last year and students and parents became used to the fact of seeing someone providing instructional material using a webcam. Virtual interactions between parties in a virtual meeting session have also attempted to solve many issues during the pandemic.

Also, even in a non-pandemic world, many factors impede people from acquiring services in the real world. Those include lack of time, far distances, lack of budget, and also lack of awareness of the existence of such services. Also, the need for help or advice or tutoring oftentimes arises suddenly and, in many instances, in reference to an imminent issue.
Parents seeking medical advice and the doctors who are experts in their issue is nowhere to be found.
A couple working on losing weight and have a personal trainer with them all the time
A student having an approaching exam and needs one on one tutor support
A woman seeking legal advice from the best attorney in the country without paying too much
A housewife looking for how to perfectly cook a turkey and needs one on one support.
The list goes on to include any remote service that can be delivered online and has demand.

The motivator for this invention is that many people have services, talents, skills or knowledge they can offer online (referred to “Tutors”) and many others are looking for those services (referred to “tutees”). However, how do we guarantee a perfect match? One tutor could be exceptionally good on tutoring one topic, but completely useless in another topic. The rigid hours of real-world centers that provide similar services may not accommodate the urgent and timely needs of potential tutees. As well, in the real world, knowing which tutors are most suitable for providing effective tutoring for the topic at hand can be difficult, and in many ways, depends upon word of mouth recommendations. For tutors, benefits of such an invention include: extra money to pay down debt, start saving, or just get by; income diversification where they can lose one job and “still have something”; and additional networks and career opportunities where their online services may turn into something more.

Also, normal searching for tutors which simply would display the results for the tutee in a list format with the highest reviews coming first is not practical and not efficient for many reasons:
Many direct matching tutors could have the same review score and therefore the tutee will need to make a choice themselves (most likely the first on the list) even though that tutor might not be their perfect match for the specific service they have requested.
The list of direct matching tutors might be too long to allow the tutee go through each individual profile and watch sample promo videos which is both time consuming and tiresome for the tutee.
Presuming the tutee selected one of the direct matches to book their session, there is a chance that tutor would not accept their service request which will force the tutee to do the process again with another tutor which results in a longer inefficient process.
There might not be a direct match based on the searching criteria (Topic, timing, budget range among others) and therefore the standard search would result in ‘no match found’.
The tutee is always looking for the best possible rate for their requested session and simply comparing the rates of all matching tutors does not guarantee that as many tutors might be willing to lower down their prices if they were aware of other tutors interested.
The tutee might not be aware of new tutoring availabilities in some categories. Hence, informing tutees about tutoring categories that have high interests from others is important.
Finally, the evident competition between the tutors to accept the tutee's request is not present from a standard search and select process. This competition could force the tutors to provide further incentives and evidence of their capabilities to enhance the selection process of the tutee.

### SUMMARY OF THE INVENTION

Embodiments relate to a system, method and computer readable medium for enabling online service, talent, skill, or knowledge to be arranged. According to some embodiments, the pairing of the providing party (tutor) to the customer (tutee) requesting the service is performed programmatically and/or automatically, based on multiple parameters and further communications

Embodiments show that a tutee would utilize a front-end software application in the form of a mobile app, website, or web app or other software programs to connect to system's front end linked to the tutor matching system.

Also, embodiments enable a system such as described to be implemented using commercially available smart devices. Examples of devices that may be operated by customers (tutees) or respondents (tutors) include multifunctional cellular telephony devices (e.g. APPLE IPHONE®, devices that operate the Android operating system, windows phones), and wireless network enabled devices such as laptops, netbooks or tablets (e.g. iPAD®). As such, specialized devices or components are not needed. Customers who wish to use a matching service such as described need to only download or otherwise run a program on a suitable device. Likewise, tutors who wish to participate need only to run a corresponding program on their personal device.

In particular embodiments, one or more computer systems perform one or more steps of one or more methods described or illustrated herein. In particular embodiments, one or more computer systems provide functionality described or illustrated herein. In particular embodiments, software running on one or more computer systems performs one or more steps of one or more methods described or illustrated herein or provides functionality described or illustrated herein. Particular embodiments include one or more portions of one or more computer systems.

Specifically, embodiments of the present invention match a tutee with a tutor for an online offering to be delivered online at a time convenient to both parties. Candidate tutor(s) are automatically identified based on the tutee's requested topic, previous tutees with similar attributes (nationality, location, language knowledge . . . ) and their experience with some tutors, budget range, and time availability.

One or more embodiments described herein provide that methods, techniques and actions performed by a computing device are performed programmatically, or as a computer implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. Additionally, embodiments may be implemented in the form of computer-programs, or a computer usable carrier medium capable of carrying Such a program.

According to some embodiments, individual tutors may be selected as respondents to a tutee request in 3 possible ways:
1) A normal service where the tutee will receive an ordered list of all direct matching tutors and they can directly choose one tutor after reviewing their profiles, automatically generated promo videos, review scores, etc.) who would in turn have a choice to accept their request and the online offering is delivered as per the agreed schedule, budget, format among others.
2) A tutor bidding service where an initial set of matching tutors (candidate set) is identified based on the tutee's criteria, then the tutee would broadcast the request to the candidate set who will in turn be informed of the request and the number of other direct matching tutors, the tutors in the candidate set will in turn have a choice to accept the request and provide further incentives, offers, or evidence of their match or reject the request, and finally the tutee would accept one of the offers made and continue with the online offering delivery as per the agreed schedule, budget, format among others.
3) An in-direct matching service which takes place in the event no direct matching tutors were found based on the users search criteria. In this case, the tutee has an option to forward their request to other non-matching tutors who have some similar attributes and might be interested to offer the session. Tutors approached would have a choice to view the request and then either accept or reject it. Once mutual agreement is achieved between both parties, the online offering is delivered as per the agreed schedule, budget, format among others.
4) A reverse-bidding process which takes place when a tutee sets a time limit, a maximum budget they are willing to pay for their requested tutorial topic, and the number of candidates tutors they would like to be identified. Tutors whose expertise match the topic will then be notified and required to do a reverse bidding. The tutors who offer the least rate or accept the rate requested by the tutee while satisfying the other conditions will be communicated back to the tutee. The tutee will then make their final selection or allow the system to automatically choose the first winner. This is a very important feature which allows tutees to acquire the best offer from qualified tutors.

Embodiments provide that each party is able to provide a rating or feedback of the other party for the conducted session that affects the reputation of the other party in using the system in the future. This will increase the quality of service delivered and ensures all parties respect the rules of conduct while using the service and deliver what was agreed upon.

Embodiments provide that a promo video for each identified tutor is displayed for the tutee to review before making their final selection. The promo video can either be manually entered by each tutor or/and automatically generated by the matching system by combining multiple images of the tutor, short segments of previously recorded tutor sessions with high activity (video segments where the tutor is presenting, sharing and/or talking more compared to other segments of the video), adding background music, showing comments written by other tutees in the video . . . among other video editing techniques.

Embodiments provide that the tutee can provide recommendations for their tutor and share with friends on social media the specific online offering experience.

Embodiments also show that funds are released are blocked before the online session and released after the session is conducted to the tutors account or are completely paid in advance.

In other embodiments of the present invention, identifying the final tutor to conduct the session includes identifying at first a candidate set based on the criteria (direct or indirect tutor candidate set), an accepted set based on the tutors who responded positively to the request (direct or indirect tutor accepted list), and finally a selected tutor based on the one that was accepted by the tutee (selected tutor).

In further embodiments of the present invention, searching for a direct match includes the search criteria (topic, budget, range, preferred timing) and also comparing the tutee profile with previous tutees who have experienced the tutors in the search results.

In other embodiments of the present invention, obtaining a direct matching set of tutors will notify the tutee of such and give them a choice for selecting either a standard selection process or a non-standard (bidding process) among the top matching tutors before accepting the reply of the tutors.

In further embodiments of the present invention, all parties are notified once a request was rejected either from the tutor's side or tutee's side.

In other embodiments of the present invention, broadcasting a request to either direct or indirect matches include sending push notifications and/or email messages or other communications (SMS, WhatsApp messages, . . . ) with the details of the broadcast message and further actions required.

In other embodiments of the present invention, accepting the request from the tutor's side is constrained by a time limit set by the tutee when the broadcast request was initiated which will in turn provide an incentive for the tutors to act promptly in response to a request.

In further embodiments of the present invention, a sample interface flow of the program (mobile app) is shown for a standard search, select and book, bidding request where the direct matches are automatically contacted to provide their acceptance and any related incentive they can offer before the user makes their final selection, and for an indirect match broadcast request from the tutee where other tutors will be contacted to show their interest in proving the one on one online offering.

In other embodiments, a tutor can also be a tutee as they will have a common account information but additional information is requested from the tutor.

In other embodiments, a service request becomes a service after there is a mutual acceptance from all parties of the required terms and conditions.

In other embodiments, the automatic process for displaying the different search categories for tutees is presented. According to embodiments, categories are either ‘main’ categories or ‘other’ categories and can also be subdivided further in more groups of categories. The identification of a category as either a main category or an ‘other’ category depends on the interest score of each category. The interest score is calculated based on the number of tutors joining a category and the number of tutees making a request using that category.

In another embodiment, both tutors and tutees have an automatic reward system. The reward system is based on how they interact with the matching system. This interaction comprises of: (i) the number of endorsed talents received; (ii) number of referrals; (iii) speed of response to requests and other positive interactions with the system.

According to an embodiment, the tutor can upload the recordings of the tutorial session after the session is over which will be available for the tutee for future review and reference. The recordings are also utilized by the system to automatically generate promotional videos for the tutors which can be viewed by other uses of the system.

According to an embodiment tutors are allowed to post new group tutoring topic suggestions with required funds and deadlines. Tutees can contribute to the total budget requested by making offers. The session is only conducted when the total budget goal was reached before the deadline.

In another embodiment, the system enables one or both parties to provide feedback about the other. The review provided by the tutee (for the tutor) or the tutor (for the tutee) will be used to: (1) update the average review score of that particular tutor or tutee, (2) automatically endorse a specific talent or category related to the tutorial's topic/category for that particular tutor or tutee.

In other embodiments of the present invention, a computer system matches a tutee with a tutor for a schedule online offering. A tutor matching server is configured to identify the direct matching candidate sets for the required online offering. A communication network interface is configured to receive or broadcast requests from the tutee to the candidate set and to also provide information to the tutee about the status of their requests and identification of the tutors and meeting information. The matching server may include a database of subscribed users identified as tutees and/or tutors and the database may include other information about previous experiences, reviews, profiles etc. The I/O interface may be an internet protocol interface to a digital communication network and the communication network interface may include a wireless communication network interface configured to communicate with wireless terminals associated with subscribed users. The communication network interface may further include an internet protocol interface to a digital communication network and/or a public switched telephone network (PSTN) interface.

The details of various embodiments are set forth in the accompanying drawings and the description below. Other features and advantages will be apparent from the description and drawings, and from the claims.

### BRIEF DESCRIPTION OF THE DRAWINGS

FIGS. 1A-C illustrate examples of user-interfaces that are displayed to the tutee or tutor;

FIG. 2 is an example network environment of an example tutor matching system;

FIG. 3 is an example network environment of a system front end;

FIG. 4 is an example computer system;

FIGS. 5A-D illustrate a system for online tutoring sessions according to various embodiments;

FIG. 6 is an example flowchart summarizing the automatic updates of categories;

FIG. 7 is an example flowchart summarizing the decision process in the tutor matching system;

FIG. 8 illustrates examples of a series of user-interfaces that are displayed to the tutee or tutor when logging in and accessing the front-end of the system;

FIG. 9 illustrates examples of a series of user-interfaces that are displayed to the tutee or tutor when conducting a search using the direct match-direct select;

FIG. 10 illustrates examples of a series of user-interfaces that are displayed to the tutee or tutor when conducting a search using the direct match-indirect select;

FIG. 11 illustrates examples of a series of user-interfaces that are displayed to the tutee or tutor when no direct matching tutor is found and an indirect matching tutor candidate are found;

FIG. 12 illustrates an example of a user interface for funding a group tutorial session;

Like reference symbols in the various drawings indicate like elements.

### DETAILED DESCRIPTION OF ILLUSTRATIVE EMBODIMENTS

To The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention may be embodied as a method, data processing system, and/or computer program product. Accordingly, the present invention may take the form of an entirely hardware embodiment, an entirely software embodiment or an embodiment combining software and hardware. Furthermore, the present invention may take the form of a computer program product on a computer usable storage medium having computer-usable program code means embodied in the medium.

Computer program code for carrying out operations of the present invention may be written in any programming language. The program code may execute entirely on the user's computer or mobile device, partly on the user's computer or mobile device, as a stand-alone software package, partly on the user's computer or mobile device and partly on a remote computer or server, or entirely on the remote computer or server. In the latter scenario, the remote computer or server may be connected to the user's computer through a local area network (LAN), a wide area network (WAN) or the internet.

The present invention is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

Embodiments of the present invention will now be described with respect to the figures. Embodiments of the present invention provide methods, systems and/or computer program products for automatically matching a tutee with a tutor for a requested online offering.

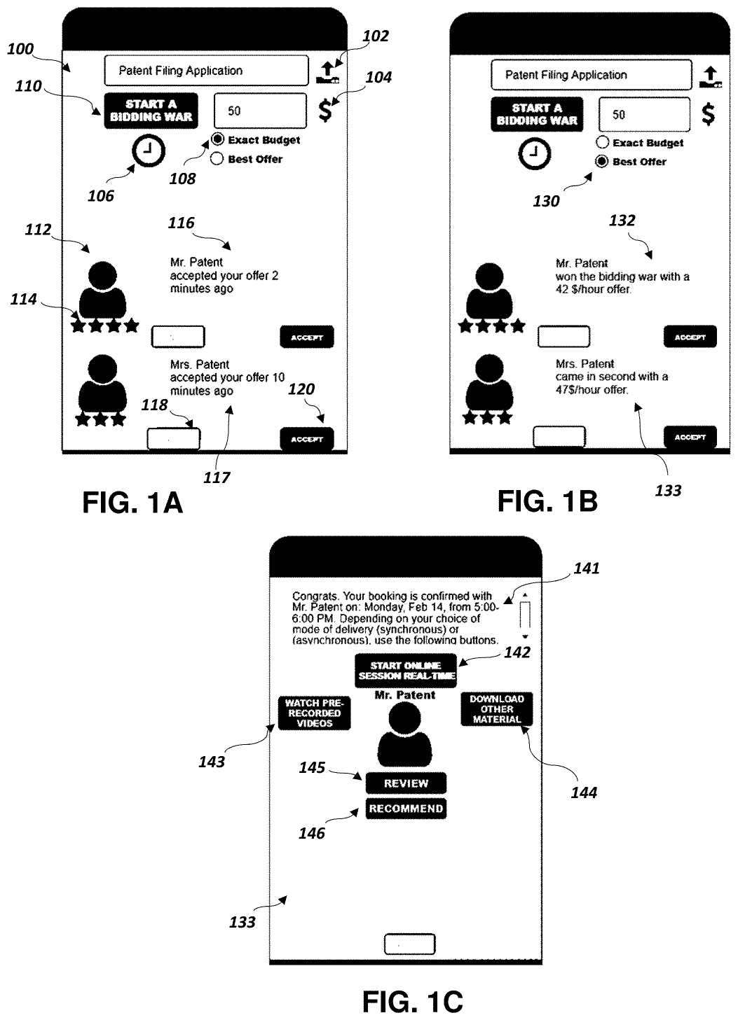

FIG. 1 illustrates an example of user-interface that is displayed to the tutee when they login and access the front end of the matching system. In this example, the tutee is given a chance to enter the search criteria (100) under a selected category they have chosen or for all categories, upload associated files (102), set their maximum budget they are will to pay per hour for the requested tutoring session (104), set a timer for the bidding process among tutors (106), select either an exact budget bidding (108) or a best offer bidding process (130), and finally start a bidding war between potential tutors in the selected category matching the tutorial topic of interest (110).

Tutors who match the topic of interest or tutors who are in the specified category only will be notified with details of the request via different means of communication channels including Emails, SMS, push notifications, message boards among others. Details of the request include the ID of the tutee requesting, access to their profile, review scores, access to any files uploaded or special considerations among other details specified by the tutee. If a time frame was specified by the tutee (106), they will also be given a limited time to submit their decisions in response to the request. Also, the number of other tutors contacted will be shared with all tutors to create a sense of competition.

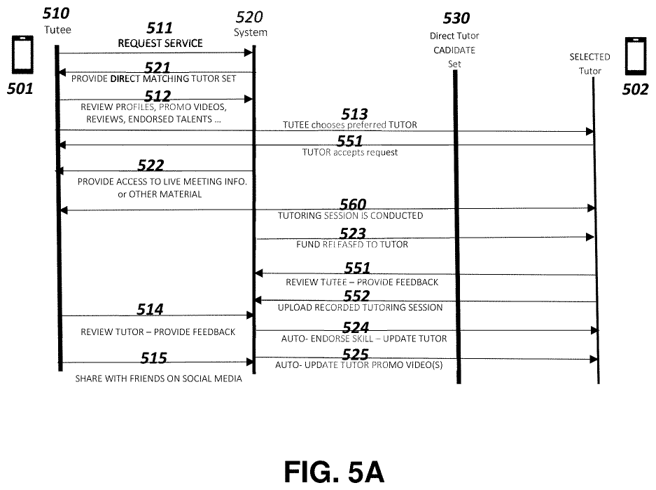

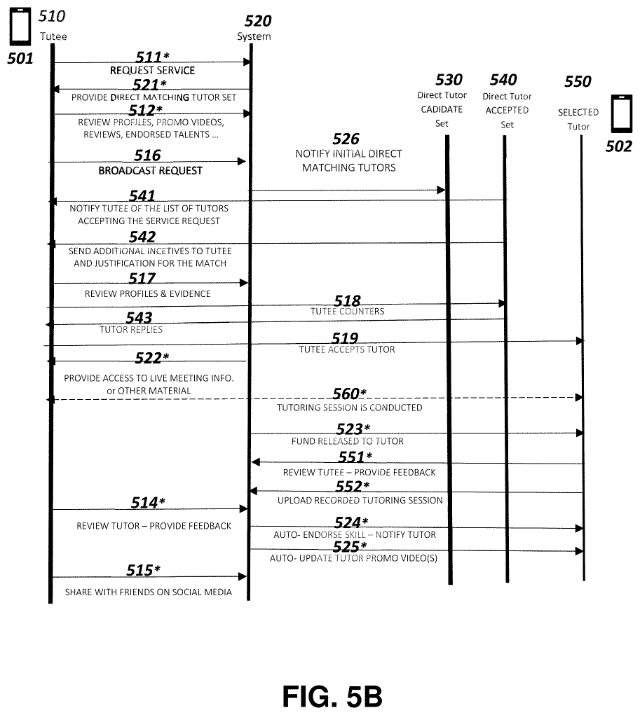

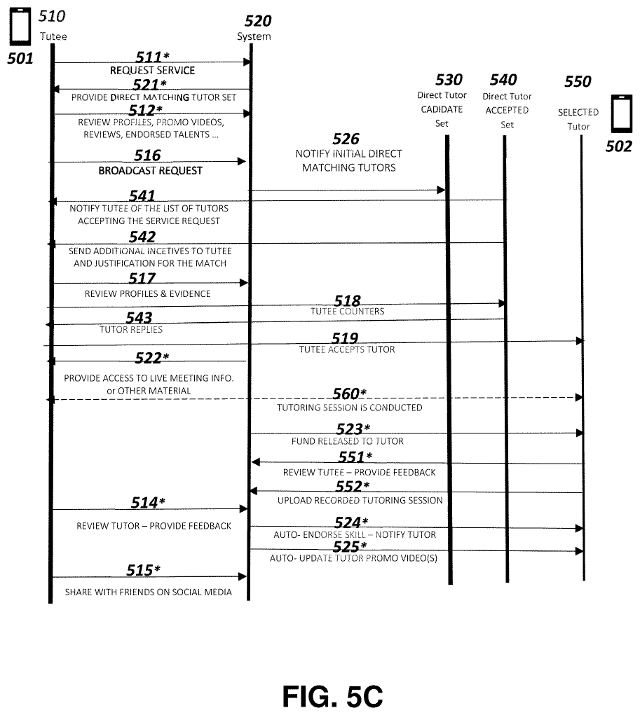

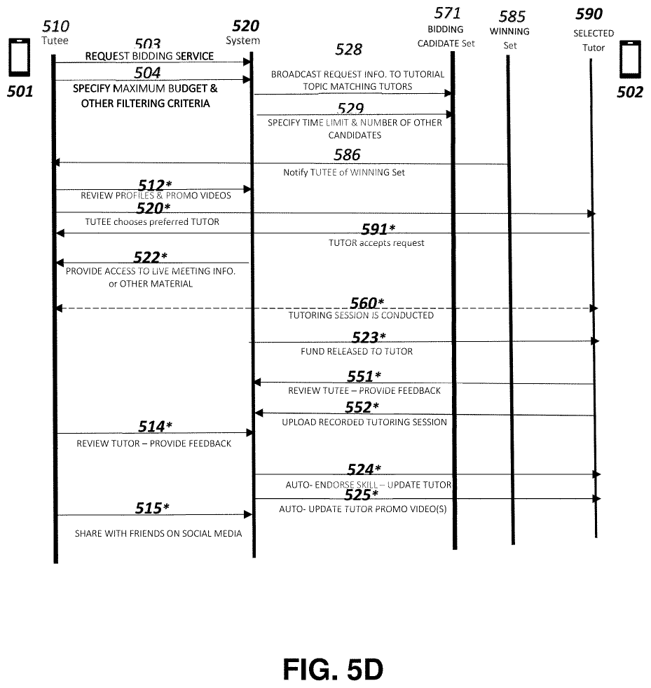

In the case of the exact budget bidding offer selected (108), tutors notified will need to either accept or reject the request and submit their decision by typically pushing or clicking on a button or any other way. As soon as their decisions have been entered, the tutee will be notified with a message similar to 116 or 117 as well as access to view the tutor's profile, endorsed talents, promo videos, among other details (118). Also, the average review score of each tutee (114) and their profile picture (112) will be displayed. The tutee will have an option to accept (120) their offers and proceed with conducting the online tutoring session in a synchronous or asynchronous manner depending on other settings they have chosen which are further explained in FIG. 5.

In the case of Best offer bidding service selected (130), tutors notified will not be informed of the maximum budget set by the tutee but will only be informed of the details of the request and asked to start a reverse bidding process where they set and reset their best offer compared to other tutors. The bidding war will end when the time limit set by the tutee is reached. Also, the tutee has a choice to allow tutors to know when their maximum budget was reached. The information about tutors who won the bid will be communicated back to the tutee as shown in 132 and 133. The tutors will also include further information including the total number of hours needed in order to deliver the topic. The tutee can then view each tutors profile, review score, profile picture, . . . and then make a choice to accept one of the tutors for the requested tutoring session.

If the tutee accepts one of the tutors offers, they will be notified with a confirmation message (141) and given access to the requested material depending on their choice of mode of delivery. They can star the online video conferencing session (142) based on selected timing, or watch pre-recorded tutorial videos made available by the tutor (143) or get access to any other material provided by the tutor (144). They can also have a direct communication with the tutor for any further requests by chatting (133). Once the session is conducted, they can review the tutor (145) and/or recommend to other friends (146). The review scores will be used to compile the average score of each tutor based on the topics and to generated automatic endorsements of talents based on the tutorial topics. Also, after the session, the tutee will get access to the recordings of the tutorial session.

Although this disclosure describes the bidding process, criteria and information shared between the tutees and tutors in a particular manner, this disclosure contemplates the bidding process, communication between all parties involved, and information shared between all parties, in any other suitable manner.

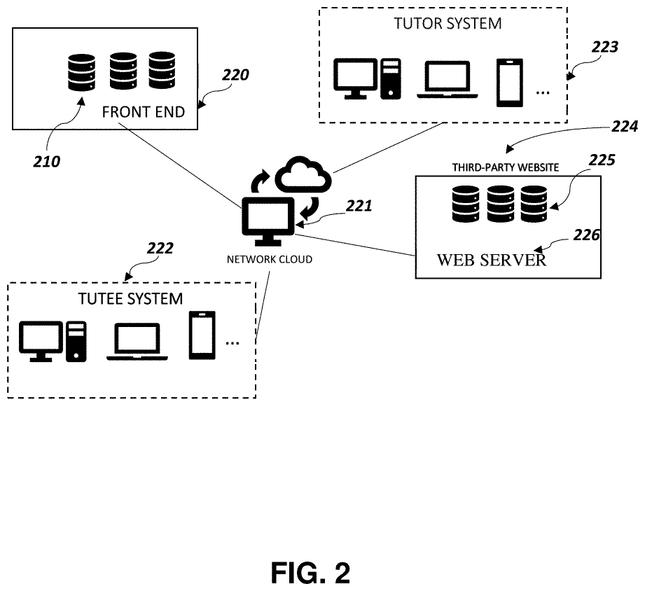

Referring to FIG. 2, a hardware and software environment including embodiments of the present invention will be described. FIG. 2 illustrates an example network environment of an example tutor matching system. In particular embodiments, a tutor matching system may comprise one or more data stores 210. As an example, and not by way of limitation, the matching system may store user profile data, system interaction information (time to respond to requests by tutors, duration of sessions, reviews, attributes, . . . etc.) in data stores 210. In particular embodiments, each data store 210 may comprise one or more storage devices. In particular embodiments, the matching system may comprise one or more computing devices (such as, for example, servers) hosting functionality directed to operation of the matching system. In particular embodiments, one or more of data stores 210 may be operably connected to the matching systems front end 220. As an example, and not by way of limitation, front end 220 may be implemented in Software programs hosted by one or more computing devices of the matching system.

A user (tutor or tutee) of the tutor matching system may access the system using a client device 222, 223. In particular embodiments, the system front end 220 may interact with the client device 222, 223 through a network cloud 221. The network cloud 221 may represent a network or collection of networks (such as the Internet, a corporate intranet, a virtual private network, a local area network, a wireless local area network, a cellular network, a wide area network, a metropolitan area network, or a combination of two or more such networks) over which a client device 222, 223 may access the tutor matching system. In particular embodiments, a client device 222, 223 may be a computer or computing device including functionality for communicating (e.g., remotely) over a computer network. As an example, and not by way of limitation, a client device 222/223 may be a desktop computer, laptop computer, personal digital assistant (PDA), smart phone or other cellular or mobile phone, mobile gaming device, another suitable computing device, or two or more such computing devices. In particular embodiments, a client device 222/223 may execute one or more client applications, such as a web browser (e.g., MICROSOFT WINDOWS INTERNET EXPLORER, MOZILLA FIREFOX, APPLE SAFARI, GOOGLE CHROME, and OPERA, etc.) or special-purpose client application (e.g., TUTORITO APP, etc.), to access and view content over a computer network. In particular embodiments, the system front end 220 may include web or HTTP server functionality, as well as other functionality, to allow users to access the matching system.

In particular embodiments, users of the matching system may access other websites or third-party websites (e.g. http://www.google.com). As an example, and not by way of limitation, a user may use a client device 222/223 to connect to and communicate with a third-party website 224 through the network cloud 221. The third-party website 224 may comprise a web server 226 operatively connected to one or more data stores 225 storing user data and other information. User data may include, for example, user name, user profile picture, and user profile information (e.g., location, affiliation, interest) and login credentials. In particular embodiments, a user may use a web browser or special-purpose client application hosted on the client device 222/223 to access a third-party website 224 in order to sign into the current matching system application.

A tutor matching system may communicate with and access a third-party website 224, and vice versa, through a network cloud 221. As an example, and not by way of limitation, a tutor's user-profile page may contain information or data collected from a third-party website (LinkedIn, google, Facebook, Instagram . . . ) 224.

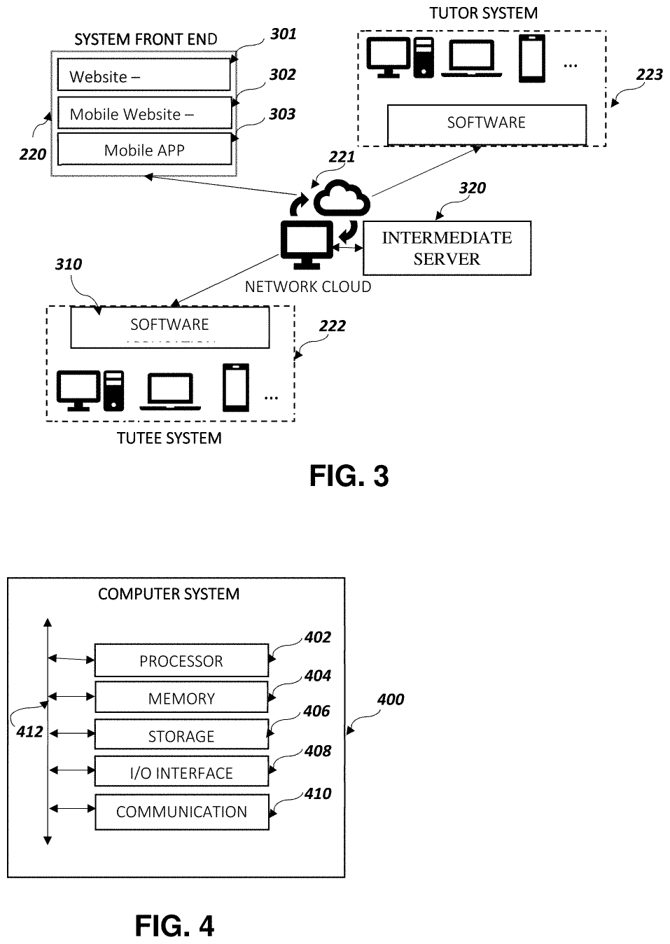

FIG. 3 illustrates an example network environment of a system front end 220 of a tutor matching system. The system front end 220 may facilitate accessing a matching system by a mobile client device 222/223. In particular embodiments, a user of a mobile client device 222/223 may choose to access the matching system via various channels. As an example, and not by way of limitation, the mobile client device 222/223 may access the standard website 301 associated with the matching system (e.g. http://www.tutoritto.com) using a standard browser client. As another example and not by way of limitation, the mobile client device 222/23 may access the mobile version of the website 302 associated with the matching system (e.g. http://m.tutoritto.com/) using a mobile browser client (e.g., any lightweight WAP browsers, FIREFOX, OPERA, GOOGLE CHROME . . . ). As yet another example and not by way of limitation, the mobile client system 222/223 may access a native mobile application server 303 associated with the matching system (e.g., a native TUTORITTO app server) using a native software application (e.g., TUTORITTO FOR IOS, or TUTORITTO FOR ANDROID). As yet another example and not by way of limitation, the mobile client system 222/223 may access an intermediate server 320, which may then access one or more channels of the matching system on behalf of the mobile client system 222/223. The system front end 220 may generate views for the mobile client device 222/223 based on the channel used to access the matching system. Although this disclosure describes accessing the matching system in a particular manner, this disclosure contemplates accessing the matching system in any suitable manner.

In particular embodiments, a mobile client device 222 may utilize one or more software applications 310. The Software application 310 may be a native software application resident in the application memory of the mobile client device, or it may be a software application stored remotely (e.g., on a third-party server). The Software application 310 may be any suitable computer program for performing any suitable activity. As an example and not by way of limitation, the software application 310 may be an application that facilitates accessing the matching system (e.g., TUTORITTO FOR IOS, or TUTORITTO FOR ANDROID). As another example and not by way of limitation, the Software application 310 may be an application that accesses data on the matching system for other uses. In particular embodiments, a matching system may receive data from or transmit data to a software application 310 through a network cloud 221. A browser cookie installed on the mobile client device 222 (e.g., by the system front end 220) may be used to facilitate accessing the matching system. As an example, and not by way of limitation, requests transmitted to the matching system from a user of a mobile client device 222 may include a browser cookie or other token to enable authentication and access to the matching system for the particular user, without the particular user having to manually enter a login ID and password information of the matching system. In particular embodiments, a Software application 310 may receive data from or transmit data to the matching system through a network cloud 221. In order to access the matching system with the Software application 310, the matching system may require the user to authenticate his identity, such as, for example by providing his unique ID (e.g., login ID and password) or by logging in using their GOOGLE, FACEBOOK or other single sign on tools. After the matching system has authenticated the user's identity, the software application 310 maybe authorized to access the matching system. Although this disclosure describes downloading particular Software applications in a particular manner, this disclosure contemplates downloading any suitable Software applications in any suitable manner. Moreover, although this disclosure describes authorizing software applications in a particular manner, this disclosure contemplates authorizing Software applications in any suitable manner.

In particular embodiments, a matching system may authenticate a user of a mobile client device 222. The user may be associated with the matching system. As an example, and not by way of limitation, a login ID and a password to authenticate a user. As another example and not by way of limitation, the matching system may access a browser cookie or other token installed by the matching system on the mobile client device 222 that indicates that the user is authenticated. Although this disclosure describes authenticating a user in a particular manner, this disclosure contemplates authenticating a user in any Suitable manner.

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example, and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement. In particular embodiments, processor 402 includes hardware for executing instructions, such as those making up a computer program. As an example, and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406.

In particular embodiments, storage 406 includes mass storage for data or instructions. As an example, and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate.

In particular embodiments, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example, and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example, and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

FIG. 5a, FIG. 5b and FIG. 5c illustrate multiple systems for enabling an online tutoring session to be arranged between parties that are at different geographic locations, according to some embodiments. In an embodiment, a tutee 510 (also referred to as customer, service recipient, or tutee) is able to make a standard request to receive an online service 511, or 516 (also referred to as online tutoring session, online offering, or service) using a computing device 501. After a series of communications between tutee 510, the matching system 520 (also referred to as the matching system or system), direct-match tutor candidate sets 530, or indirect-match tutor sets, 570 and the selected tutor 550 or 590 (also referred to as service provider or selected tutor), the matching system 520 automatically identifies the selected tutor 550 or 590 in order to conduct the online tutoring session in the form of a real time live video meeting session, a pre-recorded video tutorial session, and/or any other material for tutee 510. According to some embodiments, the tutee 510 uses a computing device 501 to generate a standard request for online service 511 or a tutor bidding service 516. As described in FIG. 2, the computing device 501 include may be a desktop computer, laptop computer, personal digital assistant (PDA), smart phone or other cellular or mobile phone, mobile gaming device, another suitable computing device, or two or more such computing devices. The network functionality enables the computing device 501 to transmit request 511 or 516 and communicate further with the system 520, candidate set 530 or 570, or selected tutor 550 or 590. The mobile device 501 may also be configured to include identification information that identifies the tutee 501 to either the system 520 or to the tutor sets 530 or 570 or selected tutor 550 or 590.

As shown in FIG. 5a, according to an embodiment, the system 520 processes the request 511 in order to identify matching candidate tutors that match the search criteria of the tutee. More specifically, the search criteria include tutorial topic, tutorial category, mode of delivery (one on one live tutoring online, pre-recorded videos on the topic, or other material), budget range, preferred timings, preferred language to be used, tutor's knowledge in multiple languages, among other possible criteria to be entered.

Using the criteria entered by the tutee is combined with other optional criteria including tutee's profile, location, age, nationality, previous tutorial sessions which the tutee have given positive reviews for, other similar tutee profiles that have requested the same or similar topics and have had good experiences with specific tutors etc. and forms the service request 511 which is sent to the matching system 520. Although this disclosure describes and illustrates a particular example of search criteria entered by the tutee as a request for service to the system and additional criteria collected by the system, this disclosure contemplates any suitable collection or combination of other criteria that will be used for the matching process. Also, in addition to the above criteria, the tutee 510 will also have an option to upload files, pictures, videos, text or other material when making the service request. Those are specifically useful when tutors are given a choice to accept such a request. For example, a tutee seeking medical advice on a swollen wrist will upload x-ray photos and other useful information about their condition when making a service request 511. Another example, a mother seeking legal advice on a due loan payment will upload her bank statements along with her request.

The system 520 is able to use the search criteria and other optional criteria and compare with existing tutors' profiles, skills, categories, endorsed talents, availability, hourly rates, ratings, among others to check if all conditions are met. If all conditions specified by the tutee 510 including the topic of interest, preferred timing of the session, mode of delivery, budget range, among others, the system 520 will provide the tutee 510 with information about a direct matching tutor set which is ordered based on their average review scores and automatically endorsed talents as shown in FIG. 5a and FIG. 5b. If some conditions were not met, the system 520 will notify the tutee that no direct matching tutor was found as shown in FIG. 5c. Also, in the case of a direct matching set of tutors found by the system 520 whose profiles and other information were communicated with the tutee 510 for their review, the tutee 510 has two choices: (i) choose their preferred tutor 550 as shown in FIG. 5a or (ii) request a tutor bidding service as shown in FIG. 5b.

In FIG. 5a, the normal tutor selection process which is also referred to direct match-direct select is summarized. After an ordered candidate list of direct matching tutors 530 were communicated with the tutee 510 by the system 520 using push notifications, email communications, web page updates, SMS, mobile app search results page, or other means of communications 521, the tutee 510 reviews 512 the direct matching tutors': (i) profile information, (ii) short promo videos uploaded by the tutors or automatically generated by the system using different short segments collected from previous recorded tutorial sessions conducted by the tutors, (ii) average review scores and tutee comments, (iii) endorsed talents which were automatically generated based on previous review scores provided by other tutees on specific categories or topics that were greater than a certain threshold, and other tutor information than are provided by the system. After the review process is conducted 512, the tutee chooses their preferred tutor 550 by manually initiating a tutorial session request 513. This can be done for example by simply clicking or pushing on a button next to the preferred tutor from the list of candidates. The selected tutor 550 who will be using a computing device 502, will be notified accordingly using push notifications, emails, SMS among other means of communication and will a choice to either accept the request or decline it. The tutor will also be given a chance to review the tutees profile, request, and other material uploaded by the tutee when making the request. If the selected tutor 550 declines the tutees request, the tutee 510 is notified and given an option to select another tutor from the list. If the selected tutor 550 accepts the request 551, which is the most likely scenario given that the matching process took into consideration the tutors preferences and availability when identifying the candidate tutors, the system 520 will notify the tutee 510 of the acceptance and provide them with further information 522 related to the upcoming tutorial session. For example, this information can include the personal meeting room of the tutor if a live session was requested, access key to the live tutorial session and ways to join the video tutorial session as per the schedule selected. Similarly, if the mode of delivery was another choice for example asynchronous pre-recorded tutorial videos, then the system will grant access to such material. Although this disclosure describes and illustrates a particular example of information or content provided by the system to the tutee upon mutual acceptance, this disclosure contemplates any suitable collection or combination of other products, services, or content that can be offered by the tutor.

The session is conducted as per the agreed schedule and mode of delivery 560 and funds are transferred from the tutees account to the tutors account 523. In an embodiment, payment is automatic. The tutee 510 may store or associate an online fund account with his device 501. Likewise, the tutor has an associated account for receiving funds. Once the tutee 110 is tutored by the tutor and the session has been conducted, system 520 can trigger transfer out of the tutee's account.

According to an embodiment, the tutor can upload the recordings of the tutorial session after the session is over (552) which will be available for the tutee for future review and reference. The recordings are also utilized by the system to automatically generate promotional videos (525) for the tutors which can be viewed by other uses of the system. This can be done by merging several very short segments of multiple tutorial recordings with high activities in them to form a short promo video that can be viewed by other tutees. The promo video can be checked and edited by the tutor for further enhancements.

Endorsed talents are also given to tutees based on the review scores of their tutors and associated tutorial topics in the same manner they were given to the tutors based on the review scores the tutee and associated tutorial topics (524). This can be useful for the tutee to become a tutor of that topic if they received enough endorsements and high review score.

Also, after the session is over, an embodiment enables one or both parties to provide feedback about the other. The tutor 550 may provide a review or feedback 551 to the system 520 about their experience with that particular tutee. Likewise, the tutee can provide a review or feedback 514 for the tutor's performance in that specific tutorial session. The review provided by the tutee will be used to: (1) update the average review score of that particular tutor, (2) automatically endorse a specific talent or category related to the tutorial's topic/category for that particular tutor 524. For example, if a student made a request for Algebra (topic) under school subjects (category, a successful direct match was found, a tutorial session was conducted, and the tutee reviewed their tutor positively then that will automatically add a talent endorsement for that tutor for algebra tutoring (talent) and school subject tutoring (category). Endorsed talents are particularly useful to make direct or indirect tutee-tutor matching and also useful when tutees are reviewing potential candidate tutors. According to an embodiment, the tutee can share their experience with friends and/or recommend their tutor to other tutees in different social media platforms using the system (515).

Endorsed talents are also given to tutees based on the review scores of their tutors and associated tutorial topics in the same manner they were given to the tutors based on the review scores the tutee and associated tutorial topics. This can be useful for the tutee to become a tutor of that topic if they received enough endorsements and high review score.

In FIG. 5b, the direct match-indirect select process is summarized. Similarly as in FIG. 5a, after an ordered candidate list of direct matching tutors 530 were communicated with the tutee 510 by the system 520 using push notifications, email communications, web page updates, SMS, mobile app search results page, or other means of communications 521, the tutee 510 reviews 512 the direct matching tutors': (i) profile information, (ii) short promo videos uploaded by the tutors or automatically generated by the system using different short segments collected from previous recorded tutorial sessions conducted by the tutors, (ii) average review scores and tutee comments, (iii) endorsed talents which were automatically generated based on previous review scores provided by other tutees on specific categories or topics that were greater than a certain threshold, and other tutor information than are provided by the system.

According to an embodiment, after the review process is conducted 512, instead of choosing directly one of the tutors as in FIG. 5a, the tutee requests for a tutor bidding service 516. This service will automatically notify all the direct matching tutors 530 in the candidate set (526). The notification which can be done using any means of communication would for example include: tutee profile information, tutee search criteria, any uploaded material by the tutee, among others. Although this disclosure describes and illustrates a particular example of information or content provided by the system to the tutors in the candidate set in order to make their decision of acceptance or rejection, this disclosure contemplates any suitable collection or combination of other information that can be communicated by the system.

According to an embodiment, the contacted tutors in the candidate set 530 will also be provided with a time limit to send back their responses as well as how many other tutors were contacted. For example, the time limit could be set to the next 10 minutes after receiving the notification which will ultimately create a sense of competition between the tutors themselves. After reviewing the information, a number of tutors in the direct tutor candidate list would either reject, ignore or accept the request. For those in the candidate direct matching list 530 who ignore the request, this will have an effect on their overall review score calculation or reward points. For example, if a tutor ignores tutee requests 3 times, this will lead to an automatic half a star reduction in their overall review score which will ultimately lead to them not being among the top tutor search results. Another example is if a tutor responds in time consistently, reward points will be added to their account.

For those tutors in the candidate direct matching list 530 who reject the request, they will be given a chance to indicate the reasons behind their rejection and their names will be removed from the candidate set 530. The reasons they mention with respect to their rejection decision can be used by the system in future tutee-tutor matching and will be saved in the backend associated with the profile of that specific tutor.

For those tutors in the candidate direct matching list 530 who accept the request made by the tutee, their name will be added to the direct tutor accepted set 540 and their information 541 will be communicated back to the tutee 510 along with any additional incentives or justifications 542 they would like to provide the tutee with before making a final decision. For example, incentives given by the accepted candidate tutors 540 could include lowering down their asking hourly rate, giving some tutoring hours for free, providing additional material for free among other possibilities 542. The tutee 510 will review once again their profiles and additional information provided by the candidate tutors 517 and have a choice to counter some or all of the offers received 518 or simply accept one of the offers provided by the candidate tutors. The process can be repeated n times where the tutors in the accepted candidate set can either reject or accept the new counter in a reply 543. Once the tutee accepts one of the tutors 550 terms of the tutoring session, the system will notify all parties and provide the needed information to the tutee 522 similar to FIG. 5a. For example, this information can include the personal meeting room of the tutor if a live session was requested, access key to the live tutorial session and ways to join the video tutorial session as per the schedule selected. Similarly, if the mode of delivery was another choice for example asynchronous pre-recorded tutorial videos, then the system will grant access to such material. Although this disclosure describes and illustrates a particular example of information or content provided by the system to the tutee upon mutual acceptance, this disclosure contemplates any suitable collection or combination of other products, services, or content that can be offered by the tutor.

Also, in a similar manner to FIG. 5a, the session is conducted as per the agreed schedule and mode of delivery 560 and funds are transferred from the tutees account to the tutors account 523. In an embodiment, payment is automatic. The tutee 510 may store or associate an online fund account with his device 501. Likewise, the tutor has an associated account for receiving funds. Once the tutee 110 is tutored by the tutor and the session has been conducted, system 520 can trigger transfer out of the tutee's account. According to an embodiment, the tutor can upload the recordings of the tutorial session after the session is over which will be available for the tutee for future review and reference. The recordings are also utilized by the system to automatically generate promotional videos for the tutors which can be viewed by other uses of the system. This can be done by merging several very short segments of multiple tutorial recordings with high activities in them to form a short promo video that can be viewed by other tutees. The promo video can be checked and edited by the tutor for further enhancements. Also, after the session is over, an embodiment enables one or both parties to provide feedback about the other. The tutor 550 may provide a review or feedback 551 to the system 520 about their experience with that particular tutee. Likewise, the tutee can provide a review or feedback 514 for the tutor's performance in that specific tutorial session. The review provided by the tutee will be used to: (1) update the average review score of that particular tutor, (2) automatically endorse a specific talent or category related to the tutorial's topic/category for that particular tutor 524. For example, if a student made a request for Algebra (topic) under school subjects (category, a successful direct match was found, a tutorial session was conducted, and the tutee reviewed their tutor positively then that will automatically add a talent endorsement for that tutor for algebra tutoring (talent) and school subject tutoring (category). Endorsed talents are particularly useful to make direct or indirect tutee-tutor matching and also useful when tutees are reviewing potential candidate tutors. Also, according to an embodiment, the tutee can share their experience with friends and/or recommend their tutor to other tutees in different social media platforms using the system.

In FIG. 5c, the on-demand tutoring selection process also referred to as indirect match-select process is summarized. Unlike FIG. 5a, and FIG. 5b, this scenario explains how the system functions if no direct matching tutor was found based on the search criteria and other criteria discussed in FIG. 5a. According to an embodiment, the system 520 will communicate back to the tutee 510 that no direct matching tutor was found 525. The tutee 510 will have a choice to request for an on-demand tutoring service 519. The on-demand tutoring request will basically broadcast 527 details of the request to all ‘almost matching’ tutors which are referred to as in-direct matching tutor candidate set 570. The notification which can be done using any means of communication would for example include: tutee profile information, tutee search criteria, any uploaded material by the tutee, among others. Although this disclosure describes and illustrates a particular example of information or content provided by the system to the tutors in the candidate set in order to make their decision of acceptance or rejection, this disclosure contemplates any suitable collection or combination of other information that can be communicated by the system.

For a tutor to belong to the in-direct tutor matching set (570), the tutoring session requirements entered by the tutee (510) along with other information must match at least X% of the tutor's profile where X is a threshold set by the system depending on how many in-direct tutors are in the candidate set. For example, assuming X was 75 then any tutors with 75% matching with the requirements will be contacted to see if they are interested and if the number of those is not enough, then the system will automatically adjust X (for example to 50) to allow for more in-direct tutors to be contacted. Also, indirect matching doesn't only compare keywords to keywords, it also does semantic and logical comparisons to decided it a tutor ‘could’ be a candidate for the tutee's requested tutorial session. For example, if the tutee requested to learn how to cook pasta and no direct matching were found then an indirect match who has in their skills or knowledge how to cook risotto (an Italian food), then that could be a potential candidate for the tutoring session if other criteria are satisfied (availabilities, . . . ).

Once contacted, the indirect matching tutors 570 will have a choice to accept the request similar to the process explain in FIG. 5a and FIG. 5b. According to an embodiment, the contacted tutors in the candidate set 570 will also be provided with a time limit to send back their responses as well as how many other indirect tutors were contacted. After reviewing the information, a number of tutors in the indirect tutor candidate list (570) would either reject, ignore or accept the request. Also, similar to FIG. 5b, for those in the candidate indirect matching list 570 who ignore the request, this will have an effect on their overall review score calculation or rewards points. Also, for those tutors in the candidate indirect matching set 570 who reject the request, they will be given a chance to indicate the reasons behind their rejection and their names will be removed from the indirect candidate set 570. The reasons they mention with respect to their rejection decision can be used by the system in future tutee-tutor matching and will be saved in the backend associated with the profile of that specific tutor.

For those tutors in the candidate indirect matching list 570 who accept the request made by the tutee, their name will be added to the in-direct tutor accepted set 580 and their information 581 will be communicated back to the tutee 510 along with any additional incentives or justifications 542 they would like to provide the tutee with before making a final decision. The tutee 510 will review their profiles, promo video, review scores, endorsed skills and any other additional information provided by the accepted in-direct candidate tutors 580 and have a choice to counter some or all of the offers received 518 or simply accept one of the offers provided by the candidate tutors 520. Similar to FIG. 5b, the process can be repeated n times until the tutee accepts one of the tutors 590 terms of the tutoring session, the system will notify all parties and provide the needed information to the tutee 522 similar to FIG. 5a, FIG. 5b. Also, in a similar manner to FIG. 5a., the session is conducted as per the agreed schedule and mode of delivery 560 and funds are transferred from the tutees account to the tutors account 523. Also, according to an embodiment, the tutor can upload the recordings of the tutorial session after the session is over which will be available for the tutee for future review and reference and be used to auto-update the tutors promo videos 525. The tutor 590 may provide a review or feedback 551 to the system 520 about their experience with that particular tutee. Likewise, the tutee can provide a review or feedback 514 for the tutor's performance in that specific tutorial session. The review provided by the tutee will be used to: (1) update the average review score of that particular tutor, (2) automatically endorse a specific talent or category related to the tutorial's topic/category for that particular tutor 524. For example, if a student made a request for Algebra (topic) under school subjects (category, a successful direct match was found, a tutorial session was conducted, and the tutee reviewed their tutor positively then that will automatically add a talent endorsement for that tutor for algebra tutoring (talent) and school subject tutoring (category). Endorsed talents are particularly useful to make direct or indirect tutee-tutor matching and also useful when tutees are reviewing potential candidate tutors. Also, according to an embodiment, the tutee can share their experience with friends and/or recommend their tutor to other tutees in different social media platforms using the system.

In FIG. 5d, the bidding service selection process is summarized. Unlike FIG. 5a, FIG. 5b, and FIG. 5c, the tutee 510 is not looking for a perfect match (time, budget, and topic expertise) however they are looking for the best deal they can get with the topic expertise being the focus of the bidding service request search (503). The tutee will however specify the maximum price they are willing to pay for the requested tutoring session (504) along with other possible filtering criteria (number of tutors to be identified, minimum review score, preferences, talents . . . among others).

The system will only broadcast (528) the bidding request to the tutors who have expertise on the tutorial topic and hence are part of the bidding candidate set 571. The system will also provide the bidding candidate set with: (i) the total number of other tutors in the bidding set; (ii) the time limit they have before the bidding is over; (iii) tutees profile info. and other criteria that might be useful in the process.

The tutee 510 can specify what bidding service they want including: (i) a bidding process where the maximum budget is shared with the bidding candidate set 571 and the tutors will either accept or reject the request; (ii) a bidding process where the maximum budget the tutee is willing to pay will not be disclosed to the bidding candidate set 571 who will in turn set(and reset) their best offer until the time set expires; however, the tutors will be able to know if that price boundary have been reached at any time during the bidding process. This will therefore encourage the tutors to provide their most competitive offers if they choose to bid.

After the bidding process is over, the information about the winning tutor set 585 is communicated back to the tutee (586). The winning set refers to the matching tutors who offered an hourly rate less than the maximum price that the tutee was willing to pay in the case they were given a chance to bid different offers or the winning set refers to those who accepted the budget specified by the tutee when bidding was not allowed. The tutee will therefore be able to review their profiles and other info. (512) before selecting their preferred tutor (520). The tutee (510) can also accept any of the tutors at any time during the bidding process without waiting for the bidding to end. Although this disclosure describes the bidding process between the tutors to provide the tutorial session in a particular manner, this disclosure contemplates the bidding process and communication in any other suitable manner. The rest of the process flow after the selected tutor has accepted the request (591) in FIG. 5d is identical to that in FIG. 5c.

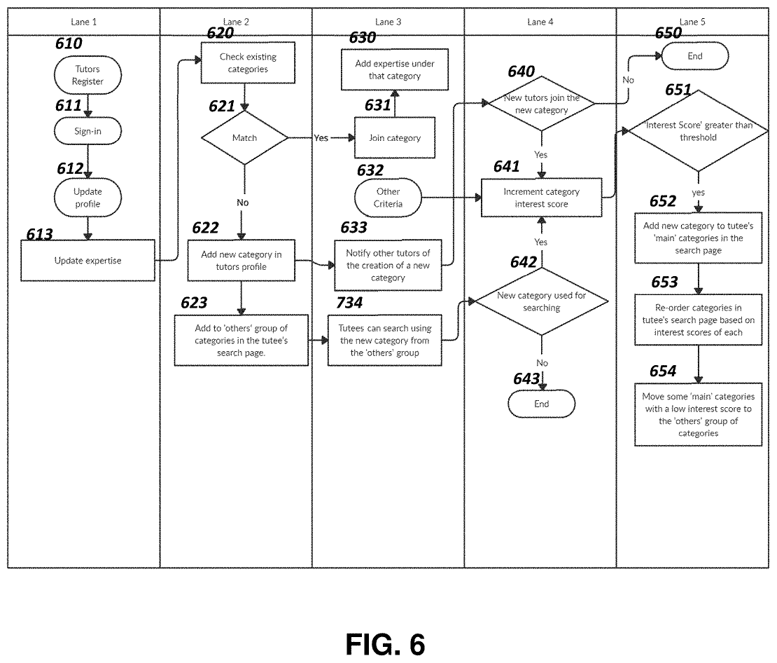

FIG. 6 summarizes the automatic process for displaying the different search categories for tutees. Basically, the tutorial search topics along with tutors' skills, expertise, talents, etc. should fall under categories. According to embodiments, categories are either ‘main’ categories or ‘other’ categories and can also be subdivided further in more groups of categories. In the main page for the tutees to do their choices, each main category is directly accessible by the tutee while topics in other categories are bundled together under one category called others. The identification of a category as either a main category or another category depends on the interest score of each category.

In FIG. 6, according to some embodiments, the tutor registers (610) and then signs-in to the system (611) and is required to update their profile (612) with more information (profile pic, resume, expertise, skills, promo video(s), certificates, availability, hourly rate . . . ). Although this disclosure describes specific information to be entered by the tutor (or tutee) when updating their profile information, this disclosure contemplates entering any other information that can be useful for the matching process. Among the other updates, the tutor needs to specifically take some time entering their expertise (613) which is a major factor in the matching process.

When entering their expertise, tutors would need to first check existing main categories (620) that have enough interest from tutors and tutees and are the ones that are displayed in the main search pages of the tutees as stand-alone categories and not bundled together in an others group of categories. For example, those main categories could include: cooking, medical advice, legal advice, counseling, school tutoring, . . . among others. If the tutor's expertise's matches one of the main categories, they will simply join that category (631) and add their expertise under that category and basically join that category (630). A tutor joining a category will result in the interest score of that category being increased which will re-order the way the main categories are displayed in the search page from the highest interest to the lowest.

If however, the tutor doesn't find a matching category to their expertise, they can add a new category (622). This new category added will belong to the others group of categories (623) as it has no interest yet from other tutors or tutees. Once a new category has been added by the tutor (622), all other tutors are notified of the addition of a new category (633) and also tutees can now search using that category from the others groups of categories and not as a stand-alone main category. The newly created category can transform into a main category if enough interest is shown by tutors and tutees and that is done by automatically calculating the interest score of each category periodically and moving main categories that have low interest scores to the other categories and moving some other categories into the main group of categories.

The interest score is incremented by specific values (641) if: (i)tutees search for sessions using that category (642), (ii) new tutors join that category by adding new expertise under it (640) or (iii) additional criteria (632) set by the system including market trends and needs, user polls, . . . among others. Once the interest score reaches a specific pre-defined threshold (651) based on the interest scores of the other main categories including the main category with the least interest score, the newly created category is added to the main group of categories (652) available to the tutee in their main search page and all the main categories are ordered based on their interest score (653). Another main category with the least interest score will be swapped with the newly created category and will be added to the other group of categories (654). Although this disclosure describes accessing the main group of categories and the other group of categories in a particular manner, this disclosure contemplates accessing the swapping criteria in any other suitable manner.

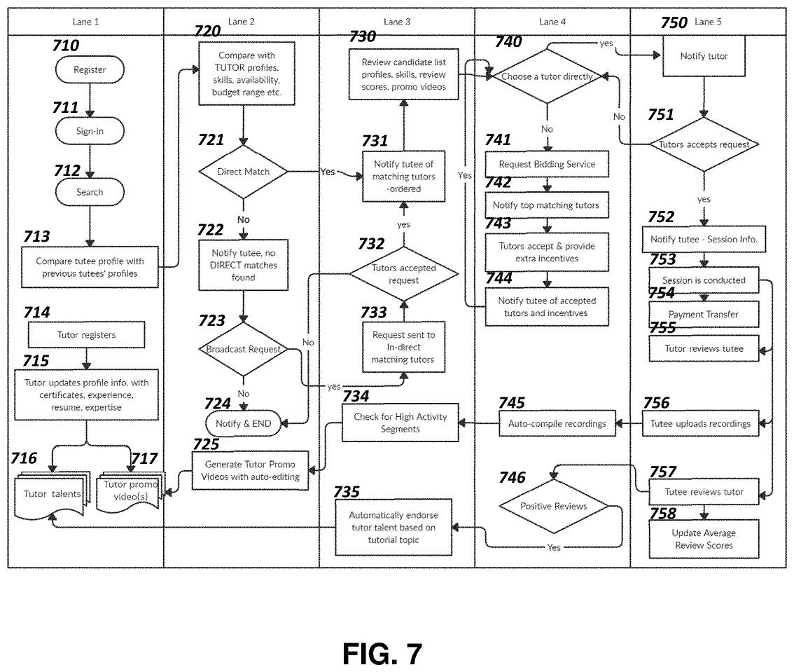

Referring now to the flowchart diagram of FIG. 7, operations for matching a tutee to a tutor for a specific request begin with the tutee registering (710), signing in (711) and then searching for a new topic (712) using searching criteria already clarified in FIG. 5a. The matching system will compare the tutee profile with previous tutee profiles who have searched for similar topics in order to refine the search results (713)

Tutors will also register, sign in and update their profiles, expertise, certificates, categories, availabilities, rate among other information discussed before in FIG. 5 and FIG. 6 (715). Two important attributes include the tutor's talents (716), and tutor's promo videos (717) which are not entered manually by the tutor but automatically generated by the system. The tutor can however upload an initial promo video or set of un-endorsed talents to be used until the system has collected enough data from the tutor's conducted tutoring sessions including tutorial session recordings, review scores, tutors' responses to requests, among other data.

After the search request have been made, tutors information (profile, skills, talents, availability, hourly rate, categories, . . . ) are compared with the search criteria and other system criteria (720) to generate a candidate set of direct matching tutors (721) and notify the tutees of the direct matching tutors (731) allowing them to review each tutor in the candidate sets individual profiles (730), then choosing a direct matching tutor directly (740), which will lead to the selected tutor being notified (750). Once the selected tutor has accepted the request (751), the tutee is notified (752) and provided with access to the tutorial session information including but not limited to the virtual meeting room info, additional material provided by the tutor, video recordings . . . etc. The session is then conducted either in real time or using pre-recorded material (753) which is followed by payment being transferred to the tutors account and dual review process where the tutor reviews the tutee (755) and the tutee reviews the tutor (757). Also, the tutor can upload the recordings of the tutorial session for the tutee to review afterward (756). This process referred to as direct match-direct select is further explained in details in FIG. 5a.

In a similar manner, the flowchart summarizes the flow on a different direction if the tutee decides not to choose directly their preferred tutor after the candidate list of direct tutors were communicated with them based on their search criteria (740→741). This process is particularly useful if the tutee is seeking: (i) a faster and better guarantee that their request will be fulfilled in time as there is a chance that their selected tutor would not accept their request and hence they will have to re-do the process again and again; (ii) more related information or evidence from the tutors with regards to their session topic before they make their decision; (iii) better discounts on the hourly rates as the process will create a sense of competition between the tutors fighting to win over the tutee and not the other way around. This process referred to as direct match-indirect select is elaborated in more details in FIG. 5b. Basically, the tutee will request a bidding service (741) which will then notify all tutors in the direct match candidate set (742) along with time constraints to respond and the number of other tutors contacted for the same. Tutors in the candidate set who accepted the request will provide further evidence or material to make their case better (743) and the system will communicate back to the tutee a refined list of accepted tutors along with any extra incentives or evidence they provide. This will in-turn continue as a normal direct match-direct select process (740).

In the event no direct matching tutors were found (721→722) based on the search criteria entered by the tutee along with any other system criteria, the flowchart summarizes the process referred to as indirect match-select process. The system will notify the tutees that no direct matching tutors were found (722) allowing them to request for a broadcast in-direct matching request (723). This will in turn broadcast the tutees request to all tutors who have some similarities with the requested search criteria but do not 100% match it. (733) Those could include higher budget than what was requested by the tutee, different timing preference, no exact match of expertise on the topic but have similar expertise on other topics, . . . The degree of similarity and the criteria used to do the indirect matching depends on many factors including the size of the indirect matching list using the default values and criteria and modifying those values to obtain an optimal size of indirect matching tutors. If the in-direct matching tutors accept the request, they will be added to the candidate set of tutors and the tutee will be notified of the list of candidate tutors (731). The process will continue the same way as the direct match-direct select or the direct match-indirect select process explained earlier. More details on this process can be found in FIG. 5c. The flowchart in FIG. 7 does not include the bidding process request flow in FIG. 5d as it was explained in details in FIG. 5d.

With regards to automatically updating the tutor's talents (716) or tutors promo videos (717), the flowchart explains a particular embodiment. Once the session is conducted (753), the tutor will normally upload the recordings of the tutorial session. Those recordings will be used by the system to automatically generate short promo videos for the tutor (717). The system will attempt to compile (745), crop and merge multiple segments of multiple tutorial recordings with high activities (less amounts of silent periods) (734) to generate tutor promo videos with any additional editing (725) and update the tutor's profile (717).

In another embodiment, after the session is conducted (753) and the tutee reviews the tutor (757), two major events happen: (i) the average review score of the tutor is updated; (ii) the review score given on that particular topic is compared with a predefined threshold (746). If the average score is more than the threshold (746→735), then the system automatically endorses the tutor with a new talent associated with the tutorial sessions topic (735) and update tutor profile with the newly endorsed talent(s) (716). This is particularly important as it allows tutors to automatically collect endorsed talents that can be used in refining future tutee-tutor matchings. Of course, the same talent can be endorsed multiple times by multiple tutees resulting in incrementing the endorsement value or strength.

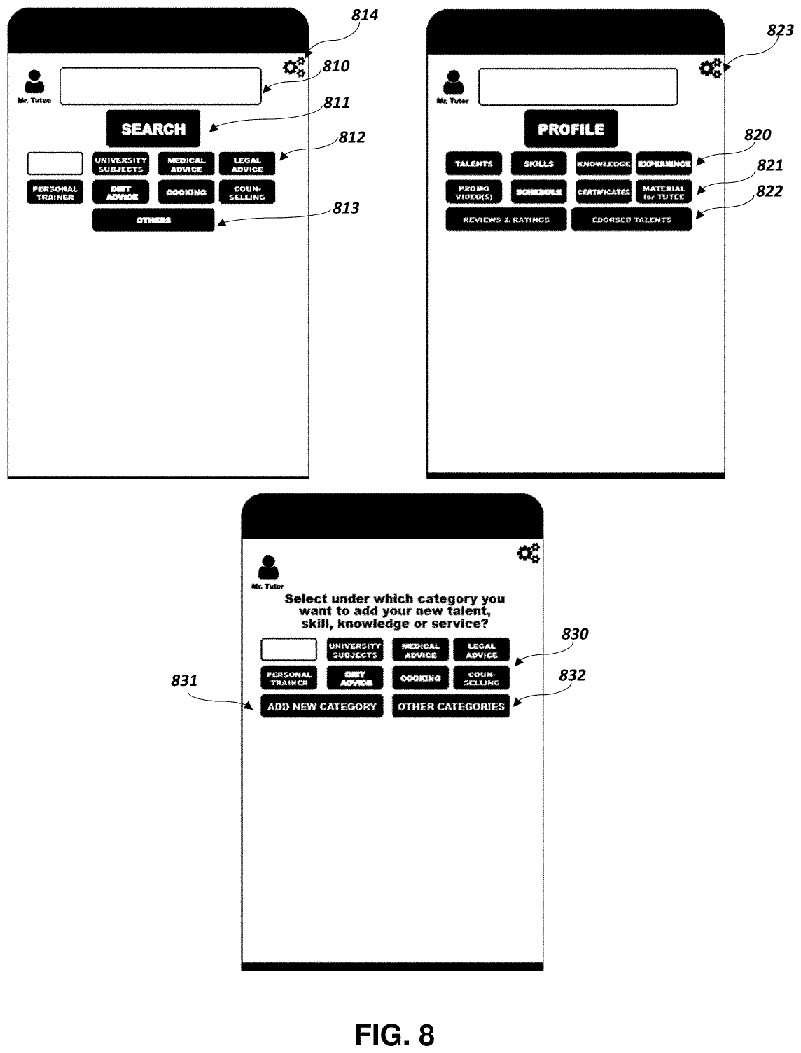

FIG. 8 illustrates examples of a series of user-interfaces that are displayed to the tutee/tutor when they login and access the front end of the system. Specifically, the tutee when performing a new search request for a specific topic of interest (810) using the search button (811), has a choice among a number of main categories (812) which have a high interest from both tutors and tutees based on the automatically calculated interest score. Also, the main categories can also include the tutee's or tutor's organization. In that case, the tutee will be given access to all tutor profiles within their organization and they can process using the system in the same manner as they would with other categories. Also, the main categories 812 (school subjects, university subjects . . . ) are ordered based on their interest score. Any category with a low interest score will be bundled together in the others group of categories (813). In another embodiment, the tutor can update their talents, skills, knowledge, or experience in their profile (820) and their promo videos, schedule, certificates and any other additional material (821). They can also check their ratings and any automatically endorsed talents. Endorsed talents result when the tutor receives a review score more than a specific threshold on a specific topic. The tutors also have to choose a specific category under which their expertise fall (830). The main categories are categories that already have high interest by other tutors or tutees. Adding their skills under those categories will further increase the interest score of those categories. The tutor also can add their expertise to other categories with a low interest rate (832) or add new categories (831) that will first be placed in the other categories and other tutors will be notified of the creating of the new category. The automatic swapping between other categories and main categories occurs when the interest rate of one of the other categories exceed that of one of the main categories and therefore those two categories will be swapped.

In another embodiment in FIG. 8, both tutors (823) and tutees (814) have an automatic reward system. The reward system is based on how they interact with the matching system. This interaction comprises of: (i) the number of endorsed talents received; (ii) number of referrals; (iii) speed of response to requests and other positive interactions with the system. For example, if a tutor responded a request within a time frame, he will be rewarded 1 or more reward points. If a tutor received an endorsement, he will also receive one or more points. The total points received can be viewed by both tutors and tutees and can be used for other purposes within the system. For example, the points can be used get discounts, higher visibility in searches among other possible utilizations.

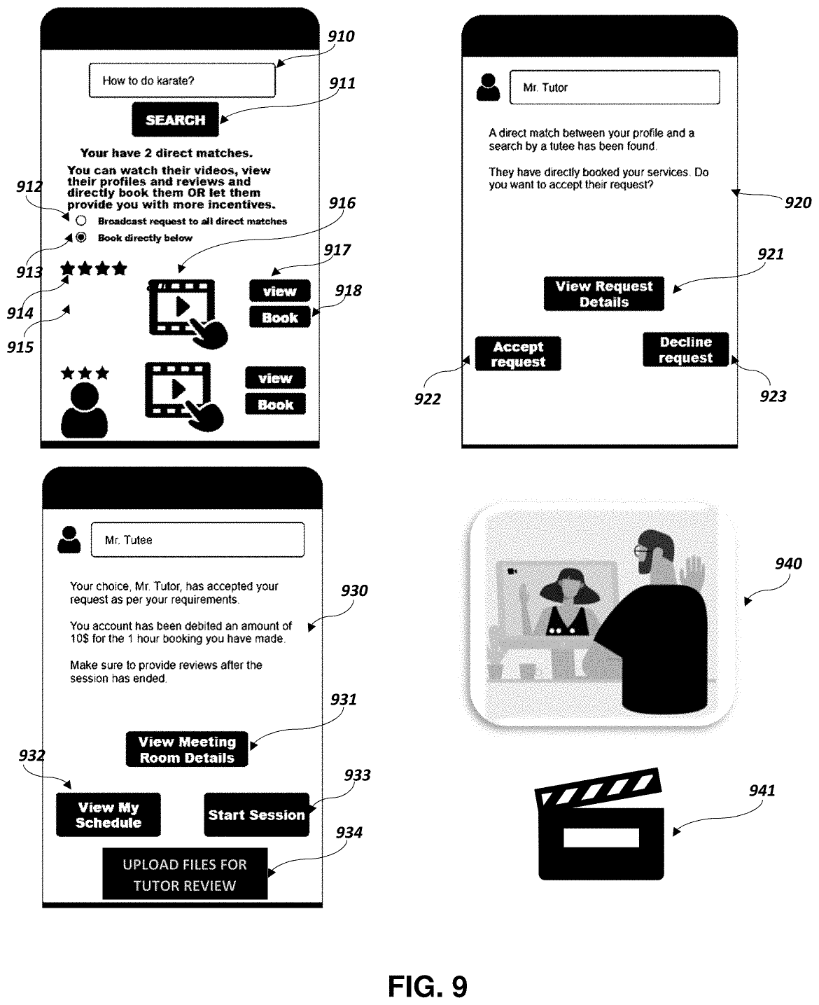

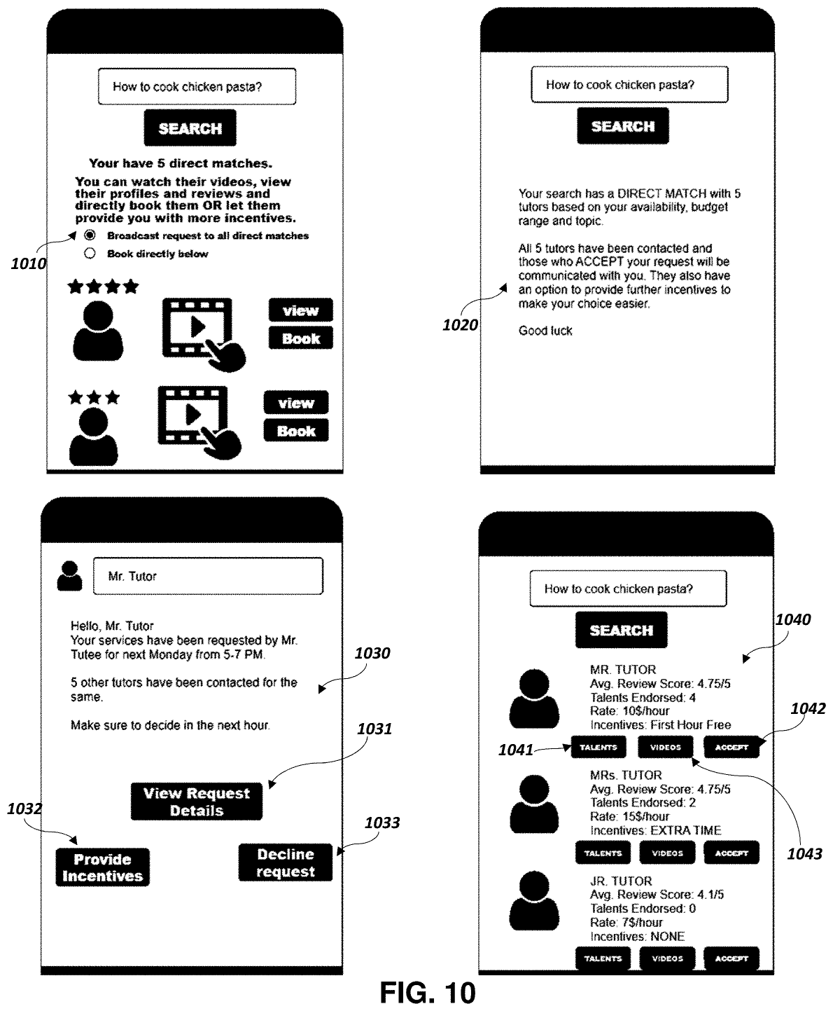

FIG. 9 and FIG. 10 illustrate examples of a series of user-interfaces that are displayed to the tutee/tutor when performing a direct matching. Specifically, in FIG. 9, after selecting their required category, the tutee enters the search topic (910) along with any additional information or special considerations they want and perform the search (911). In this case, two matching tutors are found that directly match the search criteria and any other requirements set by the tutee. The tutee can review their automatically generated promo videos or other videos by the tutor (916), view tutors' profiles, talents, experience, . . . (917), view tutors average review score (914), profile picture (915), endorsed talents among other information. The tutee will have a choice to book directly (913) or broadcast their request to all direct matching tutors (912).

Booking directly (913) a tutor, will notify them (920) and allow them to either decline (923) or accept (922) the request after they have reviewed all the request details (921). This is also referred to a direct match-direct select process. The tutee is notified (930) of the tutor's acceptance, and is given access to meeting information (931), upcoming schedule (932), a chance to upload any extra files (934) and finally a way to start the session (933) in due time synchronously (940) or asynchronously (941).

In FIG. 10, the tutee decided to choose a broadcasting request (1010) to all direct matching tutors (direct match-indirect select) resulting in sending their request to 5 tutors (1020). The system will notify all direct matching tutors (1030) and give them a chance to accept and provide further incentives (1032) or decline (1033) after reviewing the details of the request (1031). Only the information about those who accept are communicated back to the tutee (1040) who can review their information and make their final selection. Also, a reverse bidding process with specified budget as in FIG1 can also be used to make the final selection.

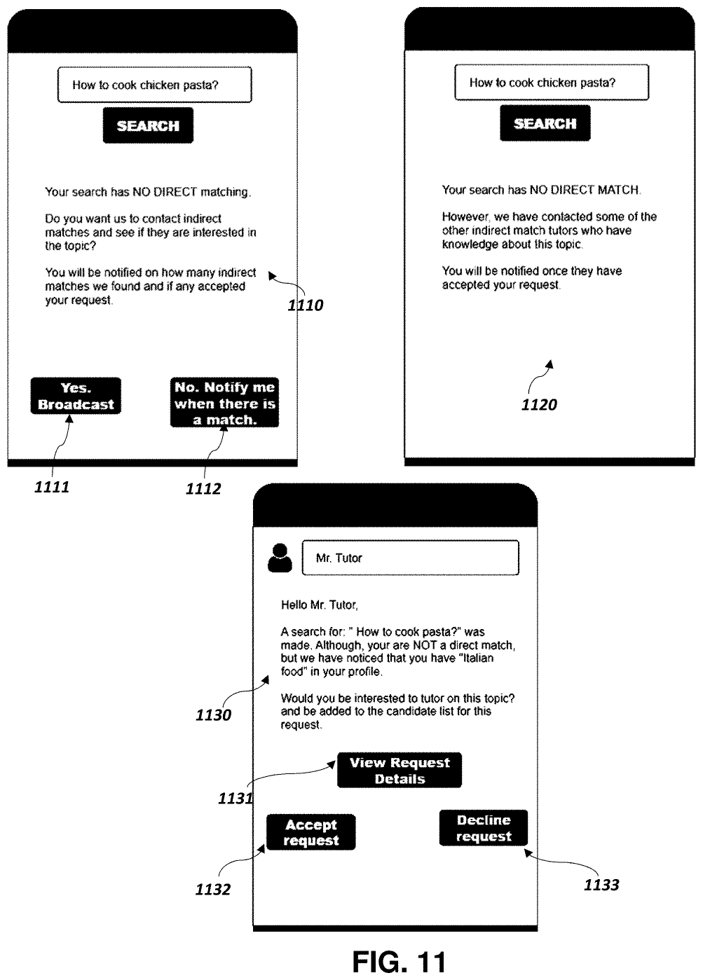

FIG. 11 illustrate examples of a series of user-interfaces that are displayed to the tutee/tutor when performing an in-direct matching. Specifically, the search resulted in no direct matching tutor (1110) and the tutee is given a choice between a broadcast message to all in-direct matching tutors who have some similar attributes to the search criteria (1111) or wait till a match is found in the near future (1112). If a broadcast message was selected (1120), all in-direct matching tutors are contacted (1130) to see if they are interested and have a choice to accept (1132), decline (1133) after reviewing the details. If accepted, the tutee will receive a list of all accepted in-direct matching tutors to make their final choice directly or start a reverse bidding process as in FIG. 1.

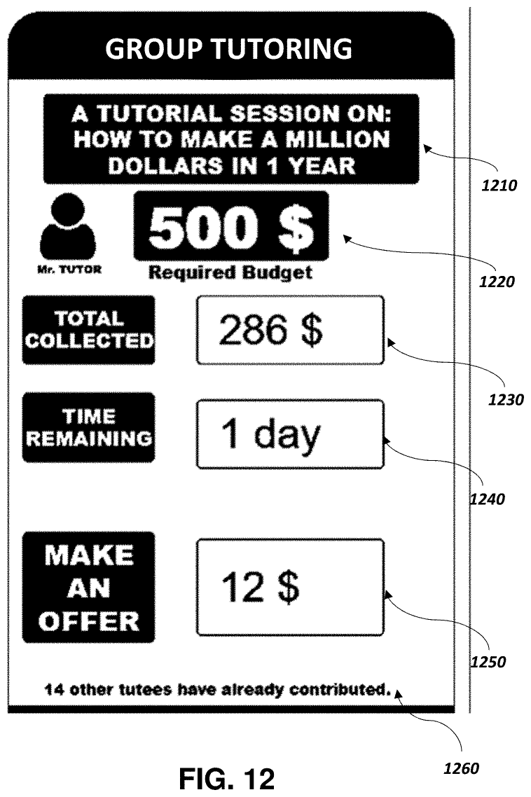

FIG. 12 illustrate an example of a user-interface that is displayed to the tutee when a tutor has posted a new tutoring session group request. Tutors are allowed to post a new tutoring topic indicating: the total budget required, time limitations, minimum offer accepted, incentives or rewards to be given to those who contribute more, among other criteria. The tutee is notified of a new tutoring session proposal (1210) and can view the total budget requested (1220) and time remaining (1240), the number of other tutees who contributed (1260) as well as the total amount of contributions made by other tutees (1230). The tutees can contribute to the total budget requested by making an offer (1250). The higher the offer, the more incentives or rewards they will be receiving when the session is being conducted. Those rewards include a one on one private meeting after the tutorial session, multiple questions to be asked during the tutorial, additional material, . . . among others. The session is only conducted if the total budget goal was reached before the deadline.

Although various embodiments have been described with reference to the Figures, other embodiments are possible. For example, according to an embodiment of the present invention, the system and method are accomplished through the use of one or more computing devices. As depicted in FIGS. 2-4, one of ordinary skill in the art would appreciate that an exemplary system 140 appropriate for use with embodiments of the present application may generally be comprised of one or more of a Central processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A method for automatically facilitating and matching one or more tutees (consumers) with one or more tutors (providers) for online services, skills, knowledge, or talents provision comprising:
automatically identifying one or more tutors for a requested online tutoring session;
automatically generating promotional material for each tutor based on prior tutorial session recordings;
automatically ordering and swapping search categories based on calculated interest scores;
automatically contacting indirect matching tutors to check for interest when no direct matching tutors were found;
providing reverse bidding functionality to tutors which allows them to offer their services at a specified price and allows a tutee to select a tutor with the best offer;
providing bidding functionality to tutees that allows tutees to bid for a tutor's service;
receiving a proposal of new tutoring session topics with specific budget goals and deadlines to be delivered by the tutor to groups of selected tutees who contribute towards those goals;
receiving uploaded additional material and information from a tutee for a tutor to review before accepting the tutee' s request and receiving uploaded material from a tutor after a session has been delivered;
providing the requested tutorial online either synchronously (in real time) or asynchronously (pre-recorded material);
receiving a post-session review, including a review score, of at least one of the tutor and tutee after the session is over;
automatically providing a talent endorsement for a tutor or tutee based at least in part on the post-session review score;
automatically providing a reward system where tutors and tutees earn points based on their positive interactions with the system; and
providing a selectable option for tutees to share or recommend their tutors on social media platforms.

2. The method of claim 1 wherein automatically identifying one or more tutors is conditioned upon: receiving the service request from the tutee, wherein the request specifies the topic of interest, categories, sub-categories and associated attachment files or material; determining the preferred timing and budget range of the tutee; determining previous tutees with similar attributes (in terms of age, spoken language, nationality, location); and identifying an initial candidate set from a plurality of tutors based on: selected topic of interest matching with tutor expertise, budget range match with tutor hourly rate, time preference matching with tutor's availability, tutor's experience with tutees having similar attributes to the requesting tutee, and an average review score.

3. The method of claim 1 wherein providing reverse bidding functionality comprises: communicating a winning bid of a tutor who offered a rate less than the tutees maximum budget back to the tutee along with the number of suggested tutoring hours to learn the requested topic.

4. The method of claim 2 wherein identifying one or more tutors further comprises: identifying a direct match set of tutors belonging to the same category and/or sub-category and allowing the tutee to review their promo videos, review scores, profiles and identifying an indirect matching set of tutors when the results of the search resulted in no direct matching tutors based on the tutee' s requirements.

5. The method of claim 4, wherein identifying a direct matching set of tutors further comprises: identifying any tutors whose profile and information directly match the criteria submitted by the tutee, including keywords, budget range, timing preference, and spoken languages; and communicating back to the tutee an ordered list of the direct matching tutors based on their average review scores and talents endorsed.

6. The method in claim 5, wherein establishing a tutoring session is conditioned upon: sending the selected tutor a request in the form of a communication message or push notifications; accepting the request by the tutor; providing online meeting information and/or other material to the tutee; processing a payment; and conducting an online session using any technological tools including but not limited to 2D and 3D video conferencing tools, mixed reality, augmented reality, virtual reality among others.

7. The method of claim 5, wherein initiating tutor bidding comprises: identifying a candidate set of direct matching tutors; alerting each tutor in the candidate set of the arrival of a new tutoring session bidding request; communicating the total number of tutors in the candidate set and the time limit for a decision to be made; allowing tutors in the candidate set to review request details and tutee profiles; and receiving confirmation of acceptance from at least one of the tutors in the candidate set with any extra incentives they would like to offer to the tutee before the tutee makes their final decision.

8. The method of claim 7, wherein providing extra incentives from tutors comprises: lowering their asking price, providing evidence of experience in tutoring the specified topic; communicating back to the tutee all the respective tutor offers and profile information including promo videos, endorsed talents, expertise, and average review scores.

9. The method of claim 4, wherein identifying the indirect match tutors set further comprises: identifying any tutors with similar topics in their profiles or similar previously conducted tutoring sessions when no direct matching tutors were found.

10. The method of claim 1, wherein automatically providing talent endorsements for tutors and tutees comprises: collecting tutee (or tutor) reviews after each conducted tutoring session on a specific topic; comparing the average review score for the tutor (or tutee) on that topic with a predefined threshold; endorsing a talent for that tutor (or tutee) if the average review score given by the tutee (or tutor) is higher that the predefined threshold; updating the tutor's (or tutee's) profile to include the new talent endorsements in additional to any previously collected talents on the same topic or different ones.

11. The method of claim 1, wherein the method further comprises: receiving registration requests from the plurality of tutors that identify the tutors including but not limited to experience, talents, skills, abilities, services provided, academic credentials, spoken languages, tutors' promo videos, and availability as a tutor; registering the plurality of tutors; allowing tutors to add their skills, talents, knowledge, or services under existing main categories that are available in the main search page for the tutees or creating new categories; and allowing the registration of a user as tutor, tutee or both;

12. The method of claim 1, wherein automatically ordering and swapping search categories comprises: adding newly created categories by the tutor to the ‘others’ group of categories in the tutees main search page; notifying all other tutors of any newly created categories; automatically calculating the interest score of the newly created category based on how many other tutors join the newly created category and/or how many tutees use that category in their searching process; automatically updating the main categories in the tutees main search page to include the newly created category if the interest score of the newly created category is above a specific threshold; automatically moving any previous main category with a low interest score to the ‘others’ group of categories; and ordering the displayed main categories according to their interest score.

13. The method of claim 1, wherein automatically generating promotional videos comprises: allowing tutors to upload short promo videos and other tutorial recordings; automatically collecting short video segments with high activities in previously recorded sessions for the tutor; combining the collected segments in a short promo video with audio or music background, images of the tutor, and comments by other tutees; updating the tutor's profile on the matching system to include the new promo video to be accessible to the tutees for review.

14. The method of claim 13, wherein high activities in previously recorded sessions comprises video segments in which the tutor is presenting, sharing and/or talking more compared to other parts of the video.

15. The method of claim 1, wherein automatically providing a reward system for both tutors and tutees comprises: totaling the number of automatic endorsements received by the tutor or tutee; comparing the response time of tutors or tutees to any request received by the system; totaling the number of referrals the tutor or tutee have made; quantifying other tutor/tutee interactions with the system including: starting the sessions on time, uploading material on time, and updating their profiles consistently; rewarding the tutor or tutee with points for every positive interaction with the system; and allowing the tutor or tutee to use the reward points for future tutoring sessions or transform them into monetary values.

16. The method of claim 1, wherein tutee bidding functionality comprises: allowing tutors to indicate their availability to conduct a one-on-one or group tutoring session; enabling tutees to bid on the tutor's online services; and creating a communication link between all parties for the session to be conducted.

17. The method of claim 1, wherein receiving the proposal for new tutoring session topics with specific funding goals comprises: receiving the request proposing the creation of a new one-on-one or group tutoring session; indicating the budget required for the tutorial session to take place; allowing tutees to indicate their interest in the tutorial session to be conducted; allowing tutees to contribute to the total budget of the proposed tutorial session; allowing the tutorial session to be conducted if the required budget goal is achieved before a specified deadline; and giving access for the tutorial session to all tutees who contributed to the budget with varying rewards depending on their contribution.

18. A system for matching a tutee with a tutor for an online tutoring session, the system comprising: means for automatically identifying a candidate set comprising one or more tutors based on a request with tutor attributes including automatically generated talent endorsements, and average review scores; reverse bidding functionality for tutors which allows them to offer their services at a specified price and allows a tutee to select a tutor with the best offer; a selectable user interface option for allowing the tutee to broadcast their request to indirect matching tutors if a direct match was not found; a selectable user interface option for allowing a tutee to select a preferred tutor from the candidate set; a selectable user interface option for providing the identified tutors an option to accept the request and provide incentives to be communicated back to the tutee; means for automatically generating a promo video for each individual tutor which combines previously conducted recordings of tutoring sessions; a selectable user interface option for providing the tutee information about an identified tutor in the candidate set including profiles, automatically generated promo videos, automatically generated talent endorsements, average review scores, experience, and offered incentives; a selectable user interface option for allowing a tutee to accept a tutor from the candidate set; a selectable user interface option for allowing the tutor to accept the request; means for conducting the tutoring session online using video conferencing tools after all parties have accepted; means for transferring a payment from a tutee account to a tutor account based on a specified agreed payment; a selectable user interface option for providing reviews and recommendations after the session has been conducted for both the tutor (reviewed by the tutee) and the tutee (reviewed by the tutor); a selectable user interface option for recommending tutors to others or sharing information on other platforms including social network platforms; means for automatically generating talent endorsements for tutors or tutees if the average review score of the tutee for the tutor (or tutor for the tutee) on the tutoring session topic is higher that a predefined threshold; a selectable user interface option for allowing tutors to create new categories under which their skills, talents, knowledge or services belong; means for automatically calculating the interest score of all categories based on how many tutors add skills under that category, how many tutees perform searches under that category and/or other criteria; means for automatically changing the main categories that show on the tutees main search page based on the interest scores of all existing categories and any newly created categories; means for automatically providing a reward system where tutors and tutees will earn points based on their positive interactions with the system.

19. The system of claim 18, further comprising: a database of subscribed users identified as tutors and/or tutees, wherein the database includes all user information including name, address, spoken language(s), experience, academic credentials, and short video promos; a communication network interface between the matching system, tutor systems, tutee systems and any third-party systems.

20. A computer-readable medium comprising instructions which, when executed by a computer, cause the computer to carry out the steps of: automatically identifying a candidate set of tutors based on a request with tutor attributes including automatically generated talent endorsements, and average review scores; generating reverse bidding functionality for tutors to offer their service at a specified price which may be selected by a tutee; generate a selectable option for a tutee to broadcast their request to indirect matching tutors if a direct match was not found; generate an option for a tutee to select their preferred tutor from a candidate set of identified tutors; providing the identified tutors with an option to accept the request and provide further evidence or incentives to be communicated back to the tutee; automatically generating promo video(s) for each individual tutor which combines previously conducted recordings of tutoring sessions; providing the tutee with information about the identified tutors including profiles, automatically generated promo videos, automatically generated talent endorsements, average review scores, experience, and offered incentives; providing a selectable option for a tutee to accept a tutor from the candidate set; providing a selectable option for the tutor to accept the tutee request; providing an online tutoring session using video conferencing tools after all parties have accepted; transferring a payment from a tutee account to a tutor account based on a specified agreed payment; generating a selectable option to provide reviews and recommendations after the session has been conducted for both the tutor (reviewed by the tutor) and the tutee (reviewed by the tutor); generating a selectable option for a tutee to recommend their tutors to others or share information on other platforms including social network platforms; automatically generating talent endorsements for both tutors and tutees if the average review score of the tutee for the tutor (or of the tutor for the tutee) on the tutoring session topic is higher that a predefined threshold; generating a selectable option for tutors to create new categories under which their skills, talents, knowledge or services belong; automatically calculating the interest score of all categories based on how many tutors add skills under that category, how many tutees perform searches under that category; automatically changing the main categories displayed on the tutees main search page based on the interest scores of all existing categories and any newly created categories; automatically generating a reward system in which tutors and tutees earn points based on their positive interactions with the system.
